(19) United States
(12) Patent Application Publication
(10) Pub. No.: US 2003/0142187 A1
(43) Pub. Date: Jul. 31, 2003

(54) Scanning carriage heat applicator

(76) Inventors: Steven B. Elgee, Portland, OR (US); Geoff Wotton, Battle Ground, WA (US); David E. Smith, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/062,758

(22) Filed: Jan. 29, 2002

(51) Int. Cl. B41J 2/01

(52) U.S. Cl. 347/102

(57) ABSTRACT

An inkjet printing mechanism includes a media support holding media in a printzone and a carriage scanning an inkjet printhead across the printzone. A heating element is supported by the carriage and moves relative to the media.

### BACKGROUND OF THE INVENTION

The present invention relates generally to printing methods and apparatus, and particularly relates to ink drying as applied in the context of inkjet printing operations.

Inkjet printing produces print imaging by propelling ink droplets onto media. A variety of inkjet printing apparatus have evolved, but generally share in the common characteristic of rendering an image by depositing liquid on a media substrate. As such, inkjet printing methods and operations sometimes include or even require drying of media, i.e., drying an evaporatable component of liquid ink following application to media as print imaging. Thus, the “wet” nature of ink as applied to produce print imaging by inkjet printers has led to the development of heating devices to promote ink drying.

Inkjet drying techniques include passing media with wet print imaging against or near heated rollers and platens. Wet print imaging will smudge, however, if the drying apparatus contacts the print imaging. The application of heat energy and consequent drying of wet media when in a curved condition, i.e., as wrapped against a roller, often results in undesirable cockling and/or buckling or curvature of output. As a result, such media often suffers in quality and in some cases requires additional processing to “flatten” the media.

Use of microwave drying in the past positioned a stationary microwave applicator downstream from a printzone to apply heat energy by microwave radiation to media passing thereby. These applicators are typically referred to as “slotted” microwave applicators or as “traveling wave” applicators.

Generally, application of heat energy to wet ink volatilizes the ink and thereby dries print imaging produced thereby. Unfortunately, volatizing ink produces ink vapor which may contaminate a printing operation and inhibit further drying. More particularly, volatilized ink compounds should be carried away from a printing operation so as to prevent excessive buildup of such compounds as volatilized or as settling back into liquid form. Thus, many ink drying methods and apparatus must carry away volatized ink compounds so as to avoid contamination of the printing operation. Accordingly, many ink drying methods and apparatus employ a separate system for carrying away and suitably venting volatized ink compounds. Volatilized ink compounds also inhibit further drying when accumulated at the media surface. In other words, volatized ink compounds tend to accumulate at a “boundary layer” of the media surface. This body of volatilized ink tends to prevent further volatilization of ink and thereby either inhibit or completely stop further drying of print imaging. Accordingly, ink drying methods and apparatus often “scrub” this boundary layer to remove a body of volatilized ink compounds from the media surface and thereby promote further productive drying of print imaging.

Ink droplets projected onto media in the printzone as liquid sometimes require supplemental drying to fully set print imaging produced thereby. Many ink formulations have been developed for improving drying time for inkjet printing applications. In addition to ink formulations, certain methods of printing, such as drop depletion, have evolved to improve ink drying time in inkjet printing applications. Ink formulations, drying mechanisms, and printing techniques optimized for ink drying time, however, often present undesirable side effects. There typically exists some compromise between drying time and other print imaging quality requirements.

### SUMMARY OF THE INVENTION

An inkjet printing mechanism includes a media support holding media in a printzone and a carriage scanning an inkjet printhead across the printzone. A heating element is supported by the carriage and moves relative to the media.

The subject matter of the present invention is particularly pointed out and distinctly claimed in the concluding portion of this specification. However, illustrated embodiments of both the organization and method of operation thereof may be understood by reference to the following description taken with the accompanying drawings wherein like reference characters refer to like elements.

### BRIEF DESCRIPTION OF THE DRAWINGS

FIG. 1 illustrates an inkjet printing mechanism, here illustrated as an inkjet printer, including one form of a scanning heater in accordance with an embodiment of the present invention.

FIG. 2 illustrates the scanning heater of FIG. 1 as taken along lines 2-2 of FIG. 1.

FIG. 3 illustrates the scanning heater of FIGS. 1 and 2 as taken along lines 3-3 of FIG. 2.

FIG. 4 illustrates the scanning heater of FIGS. 1-3 as taken along lines 4-4 of FIG. 3.

FIG. 5 illustrates the scanning heater according to the present invention as implemented by microwave applicator.

FIG. 6 illustrates the scanning heater of FIG. 5 as taken along lines 6-6 of FIG. 5.

FIG. 7A illustrates an alternative form of a microwave applicator scanning heater in section view similar to FIG. 2.

FIG. 7B illustrates the microwave applicator scanning heater of FIG. 7A as taken along 7B-7B of FIG. 7A.

FIG. 7C illustrates the microwave applicator scanning heater of FIGS. 7A and 7B as taken along lines 7C-7C of FIG. 7A.

FIG. 8 is a view similar to FIG. 2, but showing an alternative form of scanning heater making use of a radio frequency (RF) applicator.

FIG. 9 illustrates the scanning heater of FIG. 8 as taken along lines 9-9 of FIG. 8.

FIG. 10 illustrates the scanning heater of FIGS. 8 and 9 as taken along lines 10-10 of FIG. 9.

FIG. 11 illustrates schematically the electrode array of the scanning heater of FIGS. 8-10 and relative coupling to a radio frequency source.

FIG. 12 is a view similar to FIG. 2 but illustrates a second form of scanning heater using a radio frequency applicator.

FIG. 13 illustrates the scanning heater of FIG. 12 as seen along lines 13-13 of FIG. 12.

FIG. 14 illustrates an electrode arrangement for the scanning heater of FIGS. 12 and 13 and coupling thereof to a radio frequency source.

### DETAILED DESCRIPTION OF THE PREFERRED EMBODIMENT

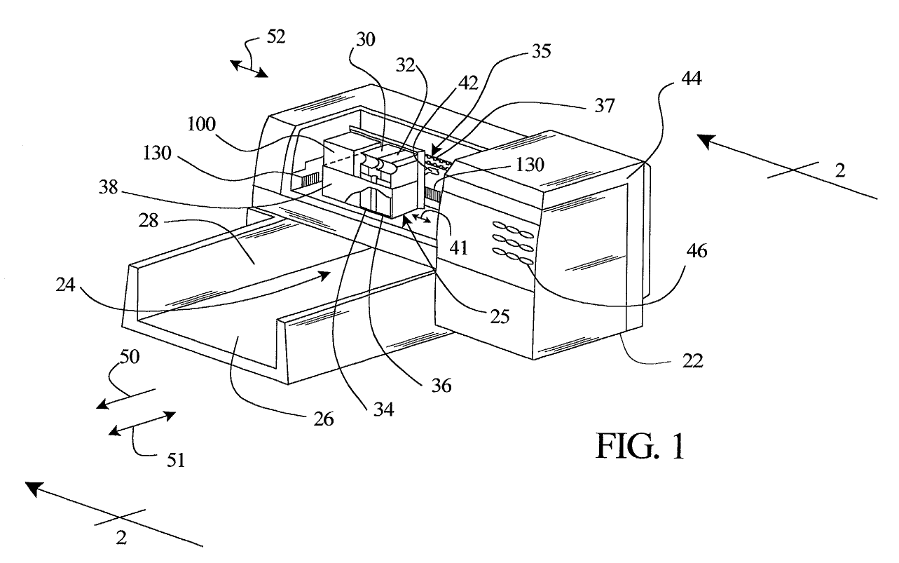

FIG. 1 illustrates a typical inkjet printing device, specifically an inkjet printer 20. The present invention will be illustrated in the context of or as applied to a typical inkjet printing mechanism, e.g. in the context of or as applied to inkjet printer 20 of FIG. 1. It will be understood, however, that printer components and particular component architectures vary from model to model and that the present invention applies across a variety of inkjet printing mechanism implementations.

Printer 20 includes a chassis 22. Within chassis 22, a print media handling system 24 supplies sheets of media (not shown in FIG. 1) to the printer 20. Media may be of a variety of generally sheet-form materials, but will be referenced herein as paper or media for the purpose of description. Handling system 24 moves media through a printzone 25 located along a feed path within chassis 22. The feed path begins at a feed tray 26 and ends at an output area 28. A variety of media transport mechanisms and techniques are known. Generally, such mechanisms and techniques include a picking device for collecting individual media from tray 26 and a set of various driven and pinch rollers propelling media along the feed path, through printer 20, and into output area 28.

As described more fully hereafter, here we are concerned with drying media following application of print imaging in printzone 25. As such, printer 20 operation will be described herein primarily with respect to media handling at or downstream from printzone 25, i.e., generally after application of print imaging to media therein.

In printzone 25, media moves longitudinally along the feed direction 50 and receives print imaging formed by projected ink droplets originating from a supply here illustrated as a replaceable inkjet cartridge, such as a black inkjet cartridge 30 and/or a color inkjet cartridge 32. Generally, cartridges 30, 32, or “pens” as referenced by those familiar with the art, hold a selected ink formulation suitable for application to a selected media or particular print job. A variety of ink formulations has evolved across a variety of uses and variety of available media.

Cartridges 30 and 32 each carry a printhead, individually referenced as printheads 34 and 36, respectively, projecting ink droplets toward printzone 25. Each printhead 34 and 36, at its bottom surface, presents an orifice plate (not shown) with a plurality of nozzles formed therethrough. Printheads 34 and 36, for example, are thermal inkjet printheads. Other types of printheads include piezoelectric printheads. While the illustrated pens 30, 32 are shown as replaceable inkjet cartridges, a broad variety of other types of pens may be substituted.

Printheads 34 and 36, implemented as thermal inkjet printheads, each include a plurality of resistors forming a resistive network associated with the printhead nozzles. Energizing a selected resistor quickly heats ink near a nozzle opening and, suddenly, a bubble of gas forms. In this manner, an inkjet nozzle “fires.” The bubble propels or ejects a droplet of ink at the nozzle, i.e. ink positioned between the nozzle opening and heated resistor. The droplet flies toward a sheet of media suitably positioned and supported in printzone 25. Application of print imaging according to a given print job includes coordinating the position of cartridges 30 and 32 within printzone 25, coordinating the position of media as supported within printzone 25, and “firing” the nozzle arrays within printheads 34 and 36 according to print imaging data.

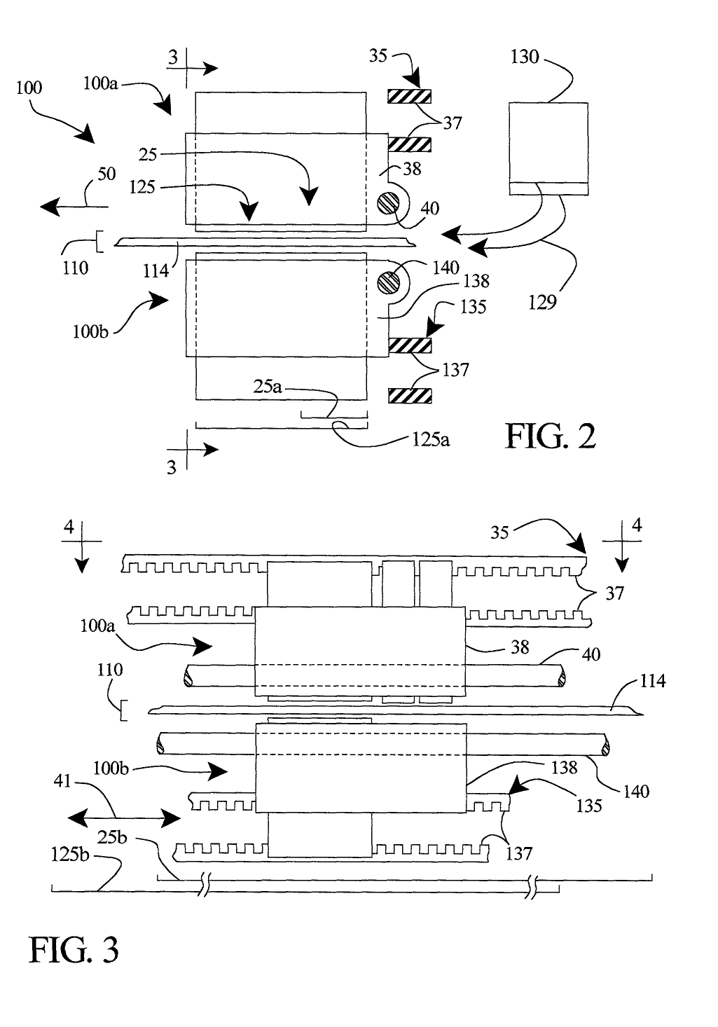

A carriage 38 holds cartridges 30 and 32, along with the corresponding printheads 34 and 36, respectively. Carriage 38 reciprocates or “scans”, i.e., moves laterally back and forth, through printzone 25. Positioning cartridges 30 and 32 during a print job includes controlled reciprocation through printzone 25 and along a scan axis 41 parallel to a lateral axis 52. A laterally-positionable carriage trolley 35 (shown partially) and a guide rod 40 (see FIG. 2) establish movement of carriage 38 back and forth laterally through printzone 25. Guide rod 40 defines scanning axis 41. More particularly, guide rod 40 may be a rigid smooth-surfaced cylindrical structure along which carriage 38 rides. Trolley 35 couples to carriage 38 and moves carriage 38 reciprocally back and forth through printzone 25. In this particular inkjet printer embodiment, trolley 35 includes a laterally disposed toothed belt 37 suspended between a driven gear (not shown) near one end of printzone 25 and an idling gear (not shown) at the opposite end of printzone 25. Thus, coupling carriage 38 to a point on belt 37 and driving belt 37 propels carriage 38 reciprocally as a trolley motor (not shown) alternates directions of rotation for belt 37.

Cartridges 30 and 32 selectively deposit one or more ink droplets on media when located in the printzone 25 in accordance with instructions received via a conductor strip 42 from a printer controller, such as a microprocessor which may be located within chassis 22 and indicated generally by reference number 44. Controller 44 may receive an instruction signal from a host device, which is typically a computer, such as a personal computer.

A printhead carriage motor and a paper handling system (neither shown) drive motor operate cooperatively in response to printer controller 44 and in manners known to those skilled in the art. The printer controller 44 may also operate in response to user inputs provided through a keypad 46. A monitor coupled to the host computer may be used to display visual information to an operator, such as the printer status or a particular program being run on the computer. Personal computers, their input devices, such as a keyboard and/or a mouse device, and monitors are all known to those skilled in the art.

To facilitate more efficient drying, printer 20 includes a scanning heater 100. Heater 100 traverses printzone 25 synchronously with pens 30 and 32. Synchronous movement of scanning heater 100 and pens 30 and 32 provides opportunity to integrate heater 100 into carriage 38, i.e., carry scanning heater 100 on the same scanning carriage holding pens 30 and 32. This both provides efficiency with respect to mechanical resources of printer 20 and locates scanning heater 100 adjacent printzone 25 with opportunity to apply heat energy to media 114 moving therethrough by generating a moving heat zone 125. There is no particular requirement, however, with respect to the relative size and position of heat zone 125 with respect to printzone 25. As such, heat zone 125 corresponds to, e.g., may be offset, congruent with, a subset of or a superset of printzone 25. In other words, heat zone 125 scans in the same manner as printzone 25, but may be of different size and/or position relative to printzone 25 than the particular embodiments illustrated herein.

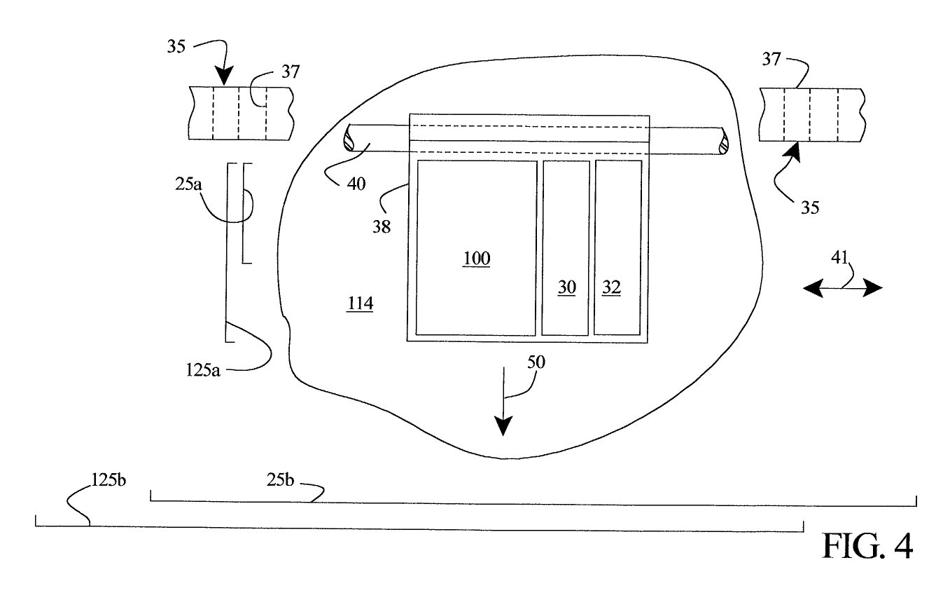

FIGS. 2-4 illustrate in greater detail scanning heater 100 as incorporated into the illustrated inkjet printing mechanism, e.g., as incorporated into printer 20 (FIG. 1). More particularly, FIG. 2 illustrates in side view scanning heater 100 as taken along lines 2-2 of FIG. 1. FIG. 3 illustrates in front view scanning heater 100 as taken along lines 3-3 of FIG. 2. FIG. 4 illustrates in top view scanning heater 100 as taken along lines 4-4 of FIG. 3.

In FIGS. 2-4, carriage 38 attaches to belt 37 and rides on guide bar 40 as described herein above. Trolley 35, alternating direction of rotation for belt 37, reciprocates carriage 38 along scanning axis 41. In this manner, printer 20 applies print imaging by “scanning” carriage 38 laterally across media 114 as media 114 advances along the feed direction 50. Thus, printheads 34 and 36 have a print swath height 25a and a printhead scan distance 25b. With scanning heater 100 mounted on carriage 38, but laterally offset relative to pens 30 and 32, scanning heater 100 has a similar carriage scan distance 125b offset relative to printhead scan distance 25b. Scanning heater 100 has a heat swath height 125a. As will be appreciated, the relative size, location, and travel path provided for pens 30 and 32 with respect to scanning heater 100 may be modified according to particular implementations of the present invention. For example, print swath height 25a need not be a particular size in relation to heat swath height 125a. A relatively longer heat swath height 125a, however, allows for multiple passes over previously printed print swaths of swath height 25a. As may be appreciated, a relatively larger heat swath height 125a permits multiple heat application scanning maneuvers relative to a shorter print swath height 25a. In other words, print imaging is exposed to heat energy through multiple exposures when the heat swath height 125a is larger than the print swath height 25a. Similarly, modifications in travel distance, size of heat zone 125, and printzone 25 are possible under the present invention.

In the particular embodiment illustrated herein, scanning heater 100 (as best seen in FIG. 3) is supported by carriage 38 and rides with printheads 34 and 36. Accordingly, heat zone 125, having a heat zone swath height 125a and a heat zone travel distance 125b scans laterally and thereby applies heat energy to media 114. Heat zone 125 preferably is located at and/or downstream from printzone 25, i.e., downstream along the feed direction 50 for printzone and/or post-printzone heating. In applications where pre-heating media 114 is desired, i.e., heating media 114 prior to entry into printzone 25, heat zone 125 may be located in part upstream relative to printzone 25. Because heat zone 125 may be placed laterally adjacent printheads 34 and 36, heat zone 125 can be located to include all or portions of printzone 25. In this manner, scanning heater 100 applies heat energy to wet print imaging and thereby promotes drying thereof. Vaporized ink developed at the “boundary layer” of media 114 during heating thereof, may be “scrubbed” from media 114 by a stationary blower 130 which generates an airflow 129. Thus, as carriage 38 reciprocates along scan axis 41 it concurrently applies print imaging and heat energy.

Thus, a heater mounted on a scanning carriage implements a scanning heater 100 as illustrated herein. A variety of heating devices may be employed in heater 100 such as resistive radiant heating elements or coils. As described further below, scanning heater 100 may be implemented as a microwave applicator or as a radio frequency (RF) applicator. In some forms of such implementations, heater 100 includes a first portion and a second portion separated by media 114 therebetween. A scanning heater 100, however, need not be implemented in such bifurcated architecture, i.e., having a first portion above media 114 and a second portion below media 114. Such architectures can be advantageous, however, especially when scanning heater 100 is implemented as a microwave applicator or as an RF applicator.

Other implementations of the present invention may apply to printing on vertical or slanted media, in such case the terms such as “upper” and “lower” only apply to the particular embodiment illustrated herein, e.g., to a generally horizontally oriented media. More appropriately, portion 100a may be considered a print surface heating element, and portion 100b an opposing or back-surface heating element.

Depending on a particular implementation of heater 100, therefore, heater 100 can be divided into an upper heater portion 100a and a lower heater portion 100b as shown in FIGS. 2-3. By coordinating scanning movement of lower heater portion 100b relative to scanning movement of upper heater portion 100a, heater portions 100a and 100b cooperatively apply heat energy to media 114 at heat zone 125.

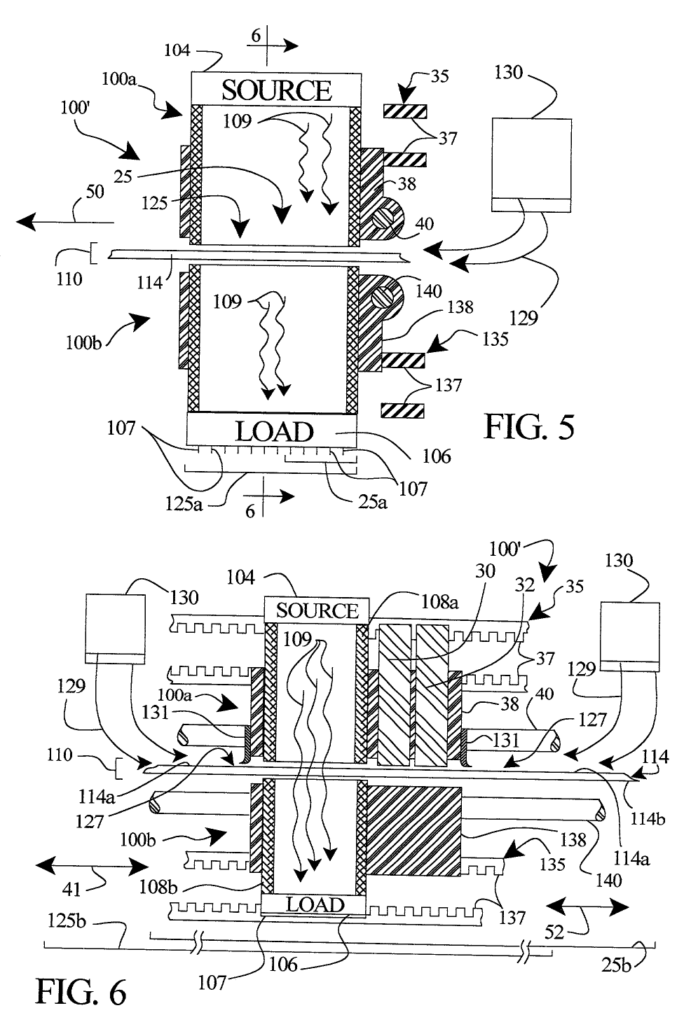

FIGS. 5-6 illustrate heater 100 as a microwave applicator heater 100′. Upper portion 100a includes a microwave source 104 and includes a waveguide portion 108a. Lower portion 100b includes a microwave load 106 and a waveguide portion 108b. It will be understood, however, that source 104 and load 106 maybe switched between an upper position and a lower position. The purpose of load 106 is to absorb any microwave energy not absorbed by print imaging on media 114. Thus, the present invention may be implemented with upper portion 100a including a load and lower portion 100b including a microwave source. Depending on a particular implementation and selected components and waveguide geometries, placing source 104 in the lower portion 100b, i.e., below media 114, may be preferred when such devices are on opposite sides of media 114. For purposes of illustration herein, however, source 104 is in the upper portion 100a, it being understood that the present invention is not limited to a particular one these possible configurations. Together, upper portion 100a and lower portion 100b form a laterally open, slotted microwave applicator. In other words, the gap 110 between upper portion 100a and lower portion 100b constitutes a “slot” or passageway as typically known for slotted waveguides. The gap 110 is laterally open to permit lateral scanning of the applicator 100′ across media 114 while scanning opposing print and backing surfaces 114a and 114b of media. Together, the upper waveguide 108a and lower waveguide 108b define a contained pathway directing microwave energy 109 therealong from microwave source 104 to microwave load 106, as indicated at reference numerals 109 in FIG. 6. Because media 114 lies intermediate microwave source 104 and microwave load 106, heater 100′ applies via microwave energy 109 heat energy to media 114 at heat zone 125.

A scrub zone 127 (FIG. 6) exists at the upward-facing print surface 114a of media 114 where air current 129 reaches media 114. In other words, where blower 130 applies air currents 129, scrubbing at the boundary layer of media 114 occurs. As may be appreciated, appropriate shielding 131 (FIG. 6) may be incorporated into carriage 38 to minimize the effect of air current 129 relative to inkjet droplet trajectory from the printheads 34 and 36.

The load 106 is propelled across the printzone 25 by a second trolley 135 which is coupled to a lower carriage 138. Lower carriage 138 slides on a lower rod 140. Lower rod 140 lies parallel to printhead carriage rod 40. Trolley 135 includes a belt 137 which may be constructed as described above for belt 37. In other words, belt 137 couples at one end to a drive gear or pulley (not shown) and is supported at the other end by an idling gear or pulley (not shown). The lower waveguide 108b and load 106 are supported by a carriage 138 which slidably couples to rod 140 and is attached to belt 137. By coordinating directions of rotation for belts 37 and 137, carriage 38 and carriage 138 preferably move synchronously relative to printzone 25 with the upper waveguide 108a suitably aligned for transferring microwave energy into the lower waveguide 108b without undesirable loss of microwave energy 109 containment or undesirable tuning effects on the overall waveguide operation.

As may be appreciated, the load 106 carried on carriage 138 moves through a body of air. Accordingly, a set of cooling fins 107 suitably aligned with respect to such relative air movement, i.e., aligned parallel to lateral axis 52 radiate heat energy away from the load and thereby provide a cooling effect relative thereto. A variety of cooling mechanisms may be employed, however, under the present invention. For example, flexible tubing can provide liquid coolant to or from carriages 38 and 138, i.e., to both source 104 and load 106, to carry away heat energy therefrom. Also, blower 130 airflow 129 further aids in cooling source 104 and load 106.

With respect to the size of a gap 110, defined between portions 100a and 100b, upper portion 100a and lower portion 100b are separated sufficient distance for media 114 to pass therebetween. Additional tolerance can be incorporated into gap 110 to account for, in addition to media thickness, cockle and manufacturing variations in media 114. Thus, gap 110 varies according to a particular application, but has been found useful at approximately 0.5 millimeters (mm).

With respect to the magnitude of heat energy required, heating and vaporizing evaporatable components of ink dispensed by pens 30, 32 takes approximately 2400 joules per cubic centimeter (2400 joules/cc). Typical inkjet printers apply approximately 10 micro liters per square inch of ink. Thus, approximately 24 joules per square inch of print imaging is the expected amount of energy required in the illustrated embodiment.

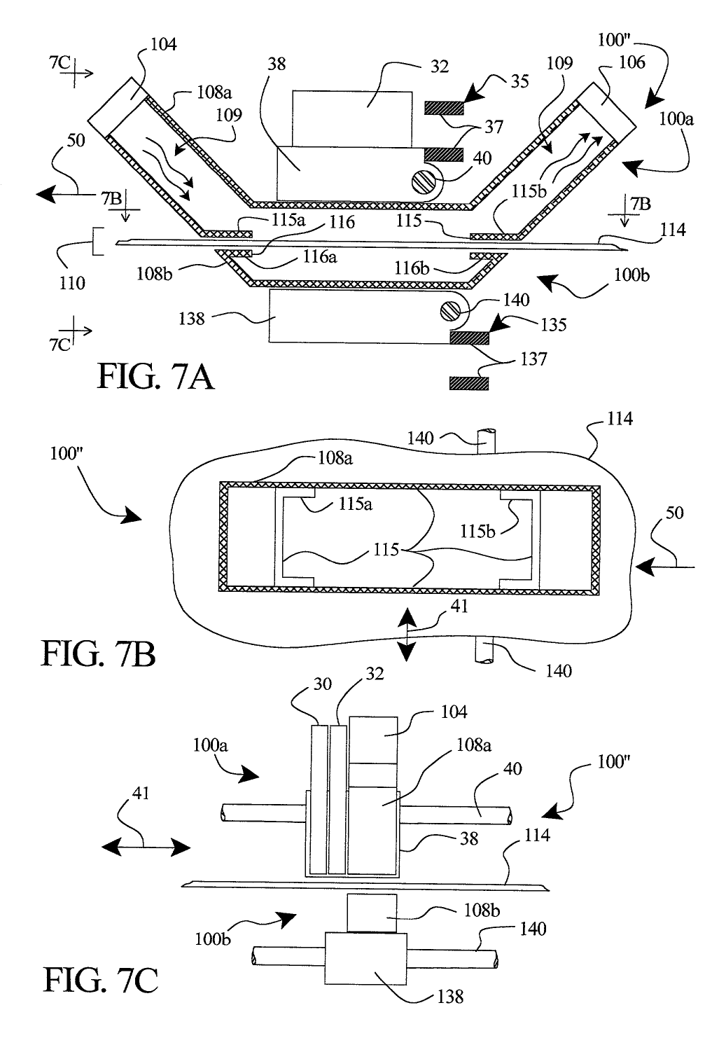

FIGS. 7A-7C illustrate an alternative waveguide structure proposed for implementation as another embodiment of the present invention as a scanning microwave applicator 100″. In FIGS. 7A-7C, heater 100″ includes an upper portion 100a maintained above media 114 and a lower portion 100b maintained below media 114. As in previous embodiments, upper portion 100a couples to upper carriage 38 and lower portion 100b couples to carriage 138. Carriages 38 and 138 move synchronously as slidably mounted on guide rods 40 and 140, respectively, and as cooperatively reciprocated by means of trolleys 35 and 135, respectively. In this particular implementation, microwave source 104 and load 106 are positioned on the upper portion 108a of a waveguide 108. The lower portion 108b of waveguide 108 is carried on lower carriage 138 as lower portion 100b of heater 100″. Overall, waveguide 108 takes the form of a fork-like structure having a first leg extending upwardly from media 114 and carrying source 104. A second leg of the fork-like structure carries load 106. An interconnecting pathway couples the first and second legs and is bifurcated by media 114. The slot or gap 110 defined between upper waveguide portion 108a and lower waveguide portion 108b allows movement of media 114 therethrough. A lower-facing opening 115 in upper waveguide portion 108a includes ledge treatments 115a and 115b. Generally, each of ledge treatments 115a and 115b are U-shaped ledge formations provided at opening 115 to prevent leakage of microwave energy 109 from waveguide 108. More particularly, waveguide 108 can be opened or slotted in certain places without significant loss of microwave energy 109 radiation. This can be done in the mid-portion of waveguide 108. Treatments 115a and 115b, therefore, are positioned to trap microwave energy 109 which would otherwise exit waveguide 108 at opening 115. Accordingly, opening 115 need only include treatments 115a and 115b at edge portions thereof apart from the mid-portion of waveguide 108. Lower waveguide portion 108b includes an upper-facing opening 116 having also positioned along selected edge portions thereof treatments 116a and 116b. Treatments 116a and 116b, also generally U-shaped (FIG. 7B) structures, are positioned to trap microwave energy 109 which would otherwise escape waveguide 108 at gap 110, i.e., through opening 116.

Thus, heater 100″ scans synchronously its upper portion 100a and lower portion 100b to maintain alignment between upper waveguide portion 108a and lower waveguide portion 108b while media 114 feeds therethrough. Optionally, the load 106 may include cooling fins as described above for fins 107.

With heater 100 implemented in the form of a microwave applicator, e.g., as heater 100′ or heater 100″, microwave drive circuitry may be incorporated into source 104 requiring only that power conductors and control conductors be routed to the scanning carriages 38 and/or 138. In other words, a flexible conductor ribbon, possibly incorporated into conductor ribbon 42, may be employed to deliver electrical energy and control signals to source 104 to produce microwave drying as described herein. As may be appreciated, controller 44 of printer 20 would suitably activate and deactivate source 104 during printing operations to coincide with application of print imaging to dry media 114 in accordance with the present invention, i.e., by scanning heat zone 125 and applying heat energy to print imaging on media 114.

FIGS. 8-11 illustrate a scanning heater 100 implemented as a radio frequency (RF) heater 100′″. Scanning RF heater 100′″ includes an upper portion 100a located above media 114 and a lower portion 100b located below media 114. Upper portion 100a includes a set of upper electrodes 204 and lower portion 100b includes a set of lower electrodes 206. Electrodes 204 ride on carriage 38 and electrodes 206 are supported by carriage 138. Accordingly, as carriages 38 and 138 scan synchronously through printzone 25, a radio or electric field 203 forms therebetween and a heat zone 125 develops between electrodes 204 and 206.

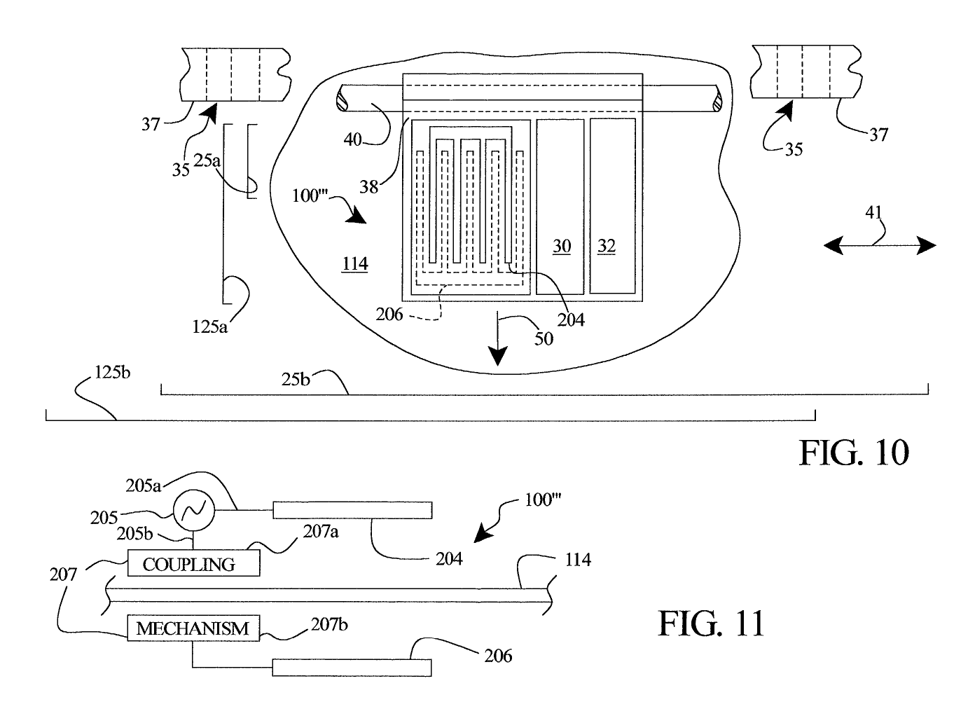

As best seen in FIG. 10, electrodes 204 and 206 may be arranged to align generally transverse to scanning axis 41 and along feed direction 50. Generally, RF electrodes used in heating applications do not align with material feed directions such as indicated by arrow 50. Relative movement between heater 100′″ and media 114, however, is dominated by the scanning motion of heater 100′″ rather than the feeding motion of media 114. Accordingly, electrodes 204 and 206 are preferably aligned as illustrated in the drawings, i.e., taking into account the predominate relative movement between heater 100′″ and media 114 is along scanning axis 41. Upper electrodes 204 are staggered relative to lower electrodes 206. In other words, electrodes 204 and 206 are arranged as a staggered stray-field electrode array. Maintaining carriages 38 and 138 in synchronized scanning movement maintains an electric field 203 in the gap 110 between electrode 204 and 206. Thus, as heat zone 125 scans across media 114, heat energy is applied therealong by electric field 203.

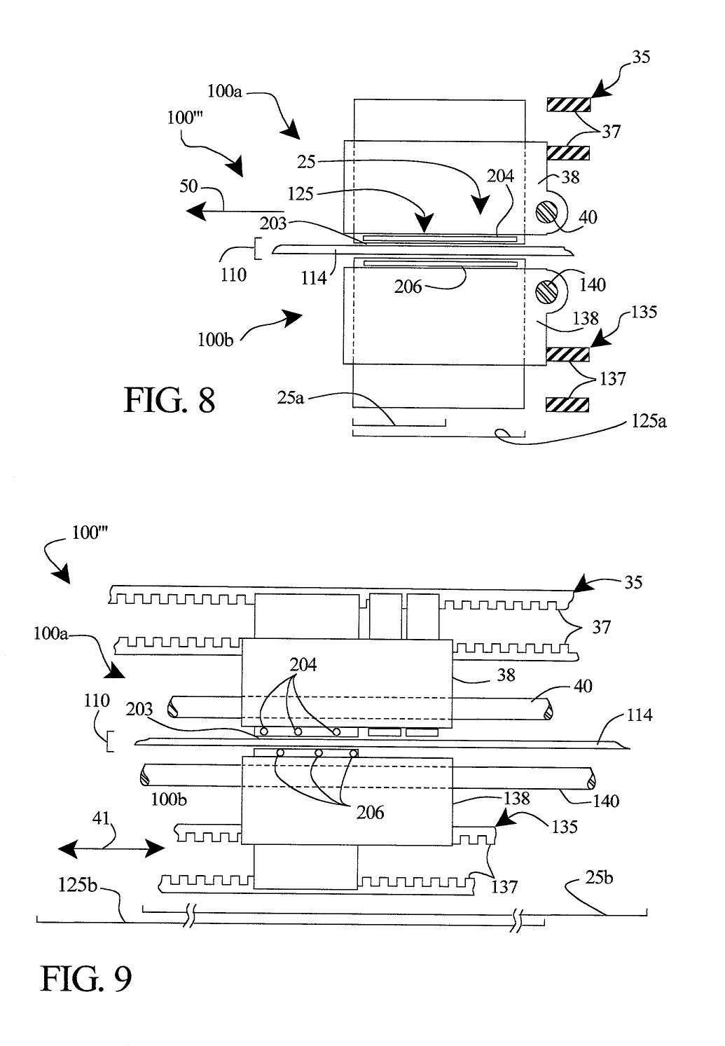

FIG. 10 illustrates the RF applicator of FIGS. 8 and 9 in top view as taken along lines 10-10 of FIG. 9. As best seen in FIG. 10, upper electrodes 204 and lower electrodes 206 are interdigitated or interleaved so as to establish a staggered relationship therebetween. In other words, for every space between lower electrodes 206, an upper electrodes 204 sits thereabove. Similarly, for every space between upper electrodes 204, a lower electrode 206 sits therebelow.

FIG. 11 illustrates one form of drive circuitry which may be used for the staggered stray-field arrangement for electrodes 204 and 206 as shown in FIGS. 8 and 9. In FIG. 11, a radio frequency source or drive circuit 205 couples at terminal 205a to electrodes 204. Terminal 205b of RF source 205 connects to electrodes 206 by way of a coupling mechanism 207. Because electrodes 204 and 206 span media 114, it is suggested that a coupling mechanism 207 be employed to couple terminal 205b to electrodes 206 through media 114. Thus, coupling mechanism 207 includes an upper portion 207a above media 114 and a lower portion 207b below media 114. Coupling mechanism 207 transfers the high frequency high power signal produced at terminal 205b through media 114 for application to electrodes 206. In other words, placing RF drive circuit 205 on one of carriages 38 and 138 finds advantage in coupling one of terminals 205a and 205b through media 114 to establish radio frequency (RF) heating a proposed under the present invention. Coupling mechanism 207 may be implemented as, for example, a parallel plate capacitor or transformer spanning media 114 and suitably coupling terminal 205b, for example, to electrodes 206. In such an arrangement, conductor 42 need only carry power and control signals to RF source 205.

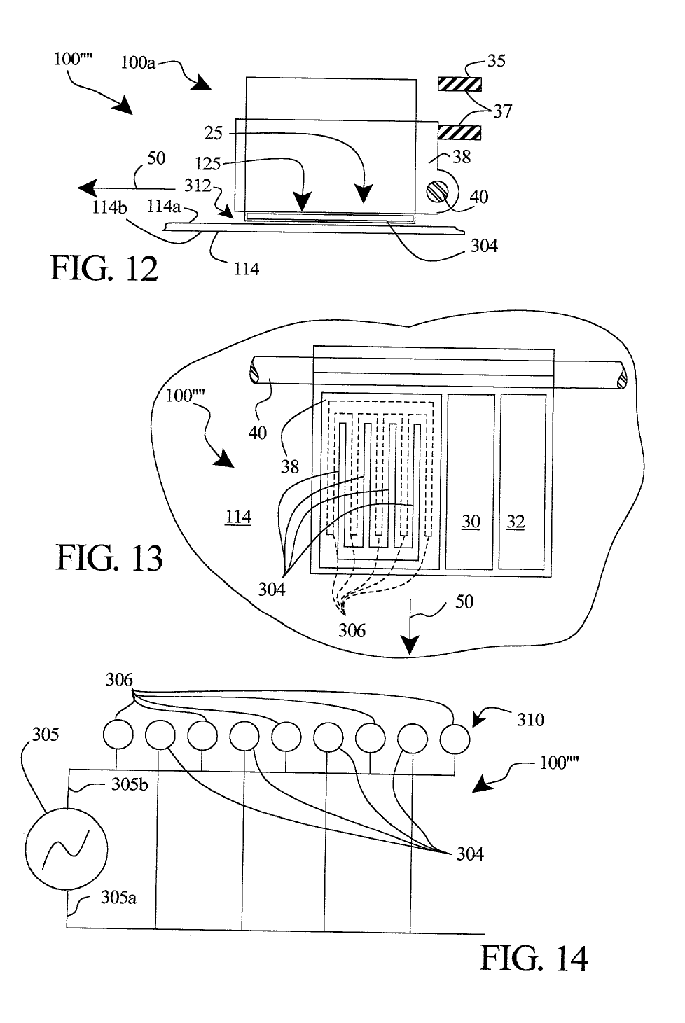

FIGS. 12-14 illustrate an alternative embodiment of a scanning RF applicator heater 100″″ employing a stray-field electrode arrangement 310 (FIG. 14) for applying heat energy on media print surface 114a by way of radio or electric field 312. In FIG. 12, a first set of electrodes 304 interleave or interdigitate with respect to a second set of electrodes 306. FIG. 13, illustrating the heater 100″″ of FIG. 12 in top view, shows the interleaved or interdigitated layout for electrodes 304 and 306. FIG. 14 illustrates the electrical circuitry associated with driving electrodes 304 and 306. Generally, a stray-field electrode arrangement is suitable for thin materials, e.g., media 114. In FIGS. 12 and 13, media 114 moves in the feed direction 50 and follows the alignment of electrodes 304 and 306 as was the case for heater 100′″ in FIGS. 8-11.

FIG. 14 illustrates circuitry driving electrodes 304 and 306 arranged to form a plane of electrode arrangement 310 and consequent electrode field 312 (FIG. 12) adjacent media 114. Heater 100″″ uses only one carriage, e.g., carriage 38 as illustrated in FIGS. 12 and 13. As may be appreciated, however, scanning heater 100″″ of FIGS. 12 and 13 could be implemented on a lower carriage 38 as described herein above but the preferred design is less complex in mounting heater 100″″ on a single carriage along with cartridges 30 and 32. RF source 305 applies alternating electric energy at terminals 305a and 305b as coupled to electrodes 304 and 306, respectively.

Alternatively, rather than using radio frequency heating, the electrodes 304, 306 may be replaced with electrically resistive radiant heating elements, such as those used in electric heaters. It is believed that substantially the same drive circuitry arrangement as shown in FIG. 14 may be used to power such resistive heating elements.

It will be appreciated that the present invention is not restricted to the particular embodiment that has been described and illustrated, and that variations may be made therein without departing from the scope of the invention as found in the appended claims and equivalents thereof.

What is claimed is:

1. An inkjet printing mechanism, comprising:
a media support which supports print media in a printzone;
a carriage which scans an inkjet printhead across the printzone; and
a heating element supported by the carriage.

2. An inkjet printing mechanism according to claim 1 wherein said heating element comprises a microwave heating element.

3. An inkjet printing mechanism according to claim 2 wherein said microwave heating element includes a first portion and a second portion, defining a heat zone therebetween.

4. An inkjet printing mechanism according to claim 3 wherein said heat zone scans synchronously with said carriage.

5. An inkjet printing mechanism according to claim 1 wherein said heating element comprises a radio frequency heating element.

6. An inkjet printing mechanism according to claim 5 wherein said radio frequency heating element includes a first portion and a second portion, a heat zone being positioned therebetween.

7. An inkjet printing mechanism according to claim 6 wherein said heat zone scans synchronously with said carriage.

8. An inkjet printing mechanism according to claim 1 further including a stationary blower producing an airflow directed at media when in the printzone.

9. An inkjet printing mechanism according to claim 1 wherein said heating element comprises a radio frequency applicator.

10. An inkjet printing mechanism according to claim 1 wherein said heating element comprises a microwave applicator.

11. An inkjet printing mechanism according to claim 1 wherein said printhead directs ink droplets into said printzone and onto said media, and said heating element creates a heat zone at a surface of said media.

12. An inkjet printing mechanism according to claim 1 further comprising a second scanning carriage, wherein said heating element has first and second portions each supported by said first carriage and said second carriage, respectively.

13. An inkjet printing mechanism according to claim 12 wherein said first and second heating element portions define a gap therebetween, said gap comprising a heat zone generated by said heating element.

14. An inkjet printing mechanism comprising:
a printzone;
a first carriage located on a first side of said printzone, said first carriage supporting an inkjet printhead and a first heater element portion; and
a second carriage located on a second side of said printzone, said second carriage holding a second heater element portion, said first and second heater element portions forming a heater element.

15. An inkjet printing mechanism according to claim 14 wherein print media in the printzone has a print surface exposed to the printhead to receive ink therefrom, and has an opposing surface opposite the print surface.

16. An inkjet printing mechanism according to claim 15 wherein said first side of said printzone faces the media print surface and wherein said second side of said printzone faces the media opposing surface.

17. An inkjet printing mechanism according to claim 14 wherein said inkjet printhead projects ink droplets into said printzone as print imaging on media when in said printzone, said print imaging receiving heat energy from said heater element.

18. An inkjet printing mechanism according to claim 14 wherein said first heater element portion comprises a microwave energy source and a first portion of a waveguide;
said second heater element portion comprises a microwave load and a second portion of a waveguide;
said first and second waveguide portions together forming a waveguide directing microwave energy from said source to said load; and
said printzone occupies space between said first portion of said waveguide and said second portion of said waveguide.

19. An inkjet printing mechanism according to claim 14 wherein said first and second heater element portions cooperatively form a microwave applicator.

20. An inkjet printing mechanism according to claim 14 wherein said printing mechanism synchronously scans said first carriage and said second carriage to maintain a selected alignment therebetween.

21. An inkjet printing mechanism according to claim 20 wherein said heating element is a microwave heating element, with at least one of said first carriage and said second carriage holding a microwave load and the other one of said first carriage and said second carriage supporting a microwave source.

22. A method of applying print imaging by ink droplet deposition on media and drying said print imaging, the method comprising the steps:
reciprocating a carriage across a printzone;
projecting from said carriage ink droplets as said print imaging; and
projecting from said carriage radiant energy applied as heat energy to said media.

23. A method according to claim 22 wherein said method comprises the step of synchronously scanning a second carriage relative to said first carriage, said second carriage holding a heater element cooperative with said heater on said first carriage to apply said heat energy to said media.

24. A method according to claim 22 wherein said heater is a microwave heater.

25. A method according to claim 22 wherein said heater is an RF heater.

26. A method according to claim 22 wherein said placing step comprises controllably advancing media in a feed direction through said printzone.

27. A printing method, comprising:
placing media in a printzone for print imaging;
reciprocating a carriage across said printzone;
projecting from said carriage ink droplets as said print imaging; and
projecting from said carriage radiant energy applied as heat energy to said media.

28. A method according to claim 27 wherein said method includes synchronously scanning a second carriage relative to said first mentioned carriage, said second carriage holding a heater element cooperative with said heater on said first carriage to apply said heat energy to said media.

29. A method according to claim 27 wherein said heater is a microwave heater.

30. A method according to claim 27 wherein said heater is an RF heater.

31. A printing method, comprising:
applying ink having an evaporatable component to a print media; and
thereafter, moving a heat zone across said media to accelerate evaporation of said evaporatable component.

32. A method according to claim 31 wherein said moving comprising scanning a heating element across said media.

33. A method according to claim 31 wherein said applying comprising scanning a printhead across said media.

34. A method according to claim 31 further comprising generating said heat zone using microwave heating.

35. A method according to claim 31 further comprising generating said heat zone from opposing surfaces of said media.

36. A method according to claim 31 further comprising generating said heat zone from RF heating.

37. A method according to claim 31 further comprising advancing said media through said printzone between each of a series of said applying and said moving.

38. An inkjet printing mechanism comprising:
means for reciprocating a carriage relative to a printzone;
printing means for applying print imaging to media in said printzone and supported by said carriage means; and
means for applying heat energy to said media and supported by said carriage means.

39. An inkjet printing mechanism according to claim 38 wherein said means for applying heat energy comprises a microwave energy source.

40. An inkjet printing mechanism according to claim 38 wherein said means for applying heat energy comprises an RF energy source.

41. An inkjet printing mechanism according to claim 38 wherein said printing means comprises an inkjet printing device projecting ink droplets therefrom.

42. An inkjet printing mechanism comprising:
a reciprocating printing device projecting ink droplets therefrom along a print swath, said print swath having a print swath height; and
a reciprocating heating element projecting energy therefrom and applied as heat energy to media adjacent thereto along a heat swath height, said heat swath height being greater than said print swath height whereby print imaging produced by said ink droplets receives said heat energy through at least a first and second reciprocation of said heating element.
